(19) United States
(12) Patent Application Publication
(10) Pub. No.: US 2006/0078266 A1
(43) Pub. Date: Apr. 13, 2006

(54) Optical engine and an image projector having the optical engine

(76) Inventors: Chao Hsien Wu, Taipei (TW); Yuan Lin Wang, Taipei (TW); Jui Wen Pan, Taipei (TW)

Correspondence Address: Raymond Sun, 12420 Woodhall Way, Tustin, CA, 92782, US

(21) Appl. No.: 11/188,183

(22) Filed: Jul. 22, 2005

(30) Foreign Application Priority Data
Oct. 8, 2004 (TW) 093130526

(51) Int. Cl. G02B 6/10

(52) U.S. Cl. 385/146

(57) ABSTRACT

An optical engine for an image projector comprises a light source, a taper rod, at least one light condenser, a prism module, a Digital Micromirror Device (DMD) and a projection lens set. One end of the taper rod is adjacent to the light source. Light generated by the light source is guided by the taper rod following a light path. The taper rod has increasing sizes of cross-sections along the light path, so as to decrease the dispersion angle of light, make the light more uniform, and increase the brightness of light. The prism module includes a first prism having a right triangle cross-section and a second prism having a wedge cross-section. The prism module receives the light from the condenser, passes the light toward the DMD, receives the light reflected by the DMD, and then passes the reflected light toward the projection lens set. The projection lens set projects the light on an external projection plane.

### BACKGROUND OF INVENTION

1. Field of the Invention

This invention is related to an optical engine. In particular, this invention is related to an optical engine located in an image projector comprising a light source, at least one light condenser, a prism module, and a projection lens set.

2. Description of the Prior Art

The quality of the image is highly related to an internal optical engine for an image projector. To get a better quality of image, the lightness, homogeneity and effectiveness of the light source should be considered into the design of the optical engine. Besides, it is of paramount importance that the light travels through the lenses and prisms should not be deflected so the image gained would not be in disagreement with the real one. No less important is the dimness of the light that will let image ends in vagueness and in low contrast. To emphasize the homogeneity of the light, massive optical lenses, polarized lenses and spectroscopes are used in a conventional optical engine. However, the lightness and effectiveness would be given in. So, in the conventional optical engine, higher power and lightness of a light source are used to get an ideal outcome. This is one of the main reasons that results in a higher energy consumption and massiveness of the optical engine.

### SUMMARY OF INVENTION

It is therefore one of the objectives of the claimed invention to provide an optical engine whose light source is homogeneous, has a higher effectiveness, lesser lenses and prisms, higher image quality, less energy consumption and comparatively small in size.

It is therefore one of the objectives of the claimed invention to provide an optical engine that comprises a light source model in which there is a taper rod. The cross-section (which is perpendicular to the light axis) of the taper rod increases gradually along the same direction as light travels. In this way, light rays will scatter less and a homogeneous and lighter light is achieved.

It is therefore one of the objectives of the claimed invention to provide an optical engine that comprises a set of prisms. This set is comprised of a first prism that is nearer to the converging lens and a second one that is farther away from the converging lens. The first prism is wedged shaped. It is manifested in cone shape along the cross-sectional surface of the traveled light source. The second prism is manifested in right triangle along the cross-sectional surface of the traveled light source. The first prism leans against the surface drawn from an edge of the right triangle along the cross-sectional surface formed by the second prism. Controlling and fine-tuning of the light's refraction angle and direction is through turning the first prism and the second prism's relative position.

It is therefore one of the objectives of the claimed invention to provide the above-mentioned image projector.

In accordance with one aspect of the present invention, an optical engine is provided, which comprises: a light source, a taper rod, at least one light condenser, a prism module, a Digital Micromirror Device (DMD) And a projection lens set. One end of the taper rod is adjacent to the light source. Light generated by the light source is guided by the taper rod following a light path. The taper rod has increasing sizes of cross-sections along the light path, so as to decrease the dispersion angle of light, make the light more uniform, and increase the brightness of light. The prism module includes a first prism having a wedge cross-section and a second prism having a right triangle cross-section. The prism module receives the light from the condenser, passes the light toward the DMD, receives the light reflected by the DMD, and then passes the reflected light toward the projection lens set. The projection lens set projects the light on an external projection plane.

### BRIEF DESCRIPTION OF THE DRAWINGS

The details of the present invention will be more readily understood from a detailed description of the preferred embodiments taken in conjunction with the following figures.

FIG. 1 illustrates an embodiment of the optical engine which is located in an image projector according to the present invention;

FIG. 2 illustrates an exploded 3-D diagram of an embodiment of the optical engine according to the invention;

FIG. 3 illustrates the exploded 3-D diagram of an embodiment of the optical engine according to the invention viewed in the other angle;

FIG. 4 illustrates the optical track of this optical engine of the invention shown in FIG. 2;

FIG. 5 illustrates a 3-D diagram of a preferred embodiment of the first prism of prism module according to the invention;

FIG. 6 illustrates a 3-D diagram of the preferred embodiment of the second prism of prism module according to the invention;

FIG. 7 illustrates a 3-D diagram of the preferred embodiment of the prism supporting piece of prism module according to the invention;

FIG. 8 illustrates an exploded 3-D diagram of a first embodiment of the illuminator module of the optical engine according to the invention;

FIG. 9 shows a diagram of an embodiment of the light is reflected along the way through the taper rod according to the invention;

FIG. 10 illustrates an exploded 3-D diagram of a second embodiment of the illuminator module of the optical engine according to the invention;

FIG. 11 illustrates an exploded 3-D diagram of a third embodiment of the illuminator module of the optical engine according to the invention;

FIG. 12 shows the combination diagram of the heat dissipating element to the illuminator module shown in FIG. 11; and

FIG. 13 shows the combination diagram of the base, concave mirror, converging lens and the prism set to the illuminator module shown in FIG. 12.

### DETAILED DESCRIPTION

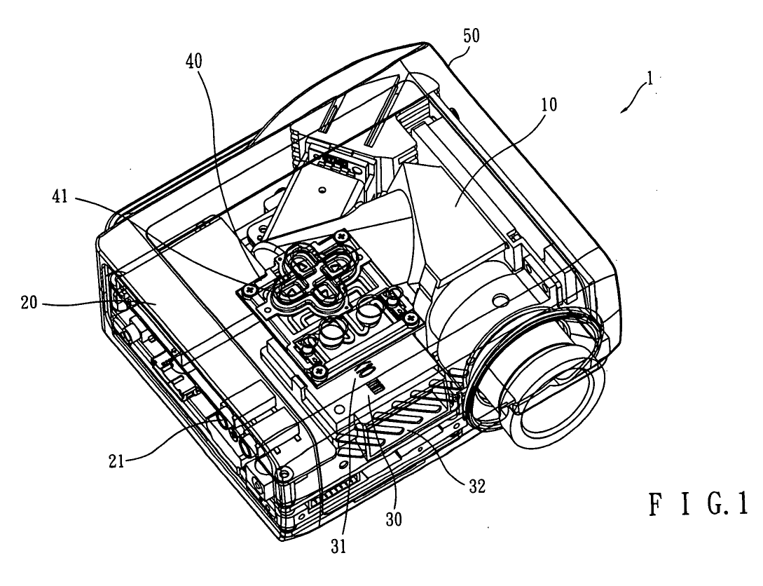

FIG. 1 illustrates an embodiment of the optical engine which is located in an image projector according to the present invention. Please refer to FIG. 1; an optical engine 10 of the present invention is furnished inside an image projector 1. The image projector 1 generally comprises the Optical Engine 10 of the invention, a PCB Module 20, a Heat Sink Module 30, Operation Interface Module 40 and a Casing 50.

The Optical Engine 10 is used to produce and project image. It is the main technical characteristic of the invention. The PCB Module 20 is connected to Optical Engine 10 to control its function. PCB Module 20 also contains several connecting interfaces 21 for connecting external devices (ex. PC, DVD or image broadcasting device, or memory card, not shown in FIG.). A Heat Sink Module 30 is used for dissipating heat from Optical Engine 10 and PCB Module 20. The Heat Sink Module 30 includes at least one fan 31, a properly devised air-flow channel (not numbered) for heat dissipation and at least one heat dissipating airway 32. A Operation Interface Module 40 is connected to PCB Module 20 for controlling the operation of Image Projector 1. In general, there are several control keys 41 or switches on Operation Interface Module 40. Optical Engine 10, PCB Module 20, Heat Sink Module 30, Interface Module 40 are all assembled inside a Casing 50.

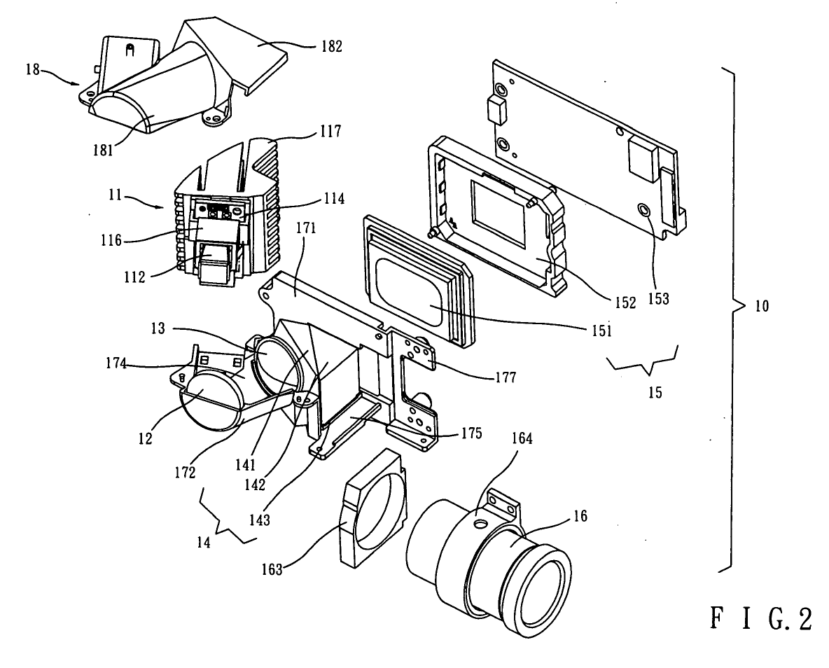

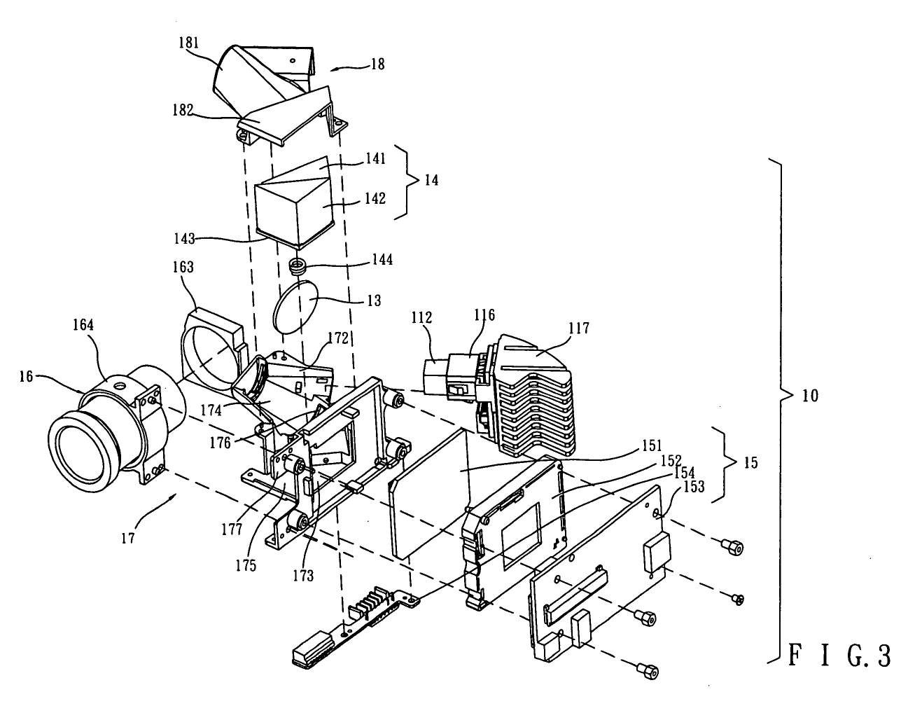

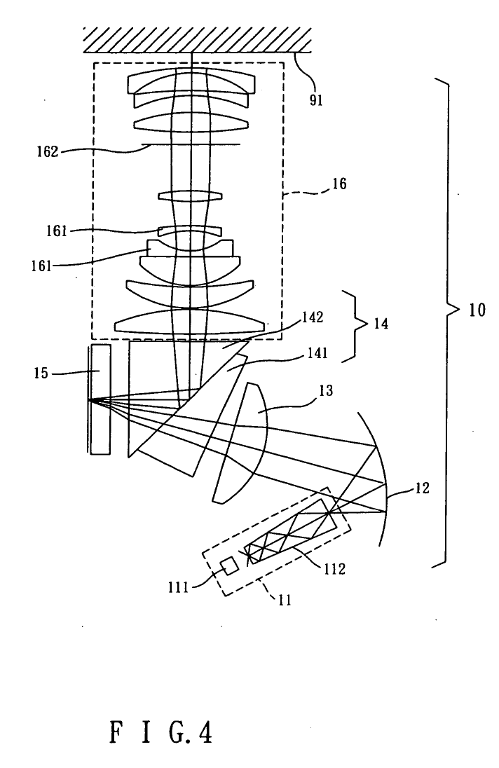

FIGS. 2, 3 and 4 illustrate embodiments of the optical engine 10 according to the invention. FIG. 2 is an exploded diagram of an embodiment of the optical engine 10 according to the invention. FIG. 3 is the exploded diagram of an embodiment of the optical engine 10 according to the invention viewed in the other angle. FIG. 4 illustrates the optical track (light path) of the optical engine 10 according to the present invention shown in FIG. 2.

As shown in FIG. 2˜4, optical engine 10 comprises an illuminator module 11, a concave mirror 12, a converging lens 13, a prism module 14, a Digital Micromirror Device (DMD) 15 and a projection lens set 16 comprising a plurality of lenses 161 and a diaphragm 162. As light projects from the illuminator module 11, the light ray is gathered first by the taper rod in the illuminator module 11. Then, the concave mirror 12 refracts and converges the light ray toward an expected direction. The light ray is then converged by the converging lens 13 and the prism module 14 refracts the light ray toward the Digital Micromirror Device (DMD) 15. As the light ray is refracted by Digital Micromirror Device (DMD) 15 and image is formed, the prism module 14 again refracts it toward the projection lens set 16 then an image is focused and formed on an external projection surface 91.

To locate the above-mentioned elements precisely, the optical engine 10 of the invention is specifically devised as shown in FIGS. 2 and 3. The optical engine 10 further includes a base 17 and an upper lid 18. The base 17 and the upper lid 18 is made of plastic materials, manufacture with injection molding technique. Upon the base 17, there are a right cover 171 and a lower lid 172. Inside the right cover 171, a first space 173 is formed to the contain Digital Micromirror Device (DMD) 15 and in the lower lid 172, a v-shaped lower concave base 174 and a below-prism shading piece 175 connected in adjacent to right cover 171 are formed. Also, there is a lower concave groove 176 located between v-shaped lower concave base 174 and below-prism shading piece 175. Upper lid 18 provides connection for lower lid 172 of base 17. Upon upper lid 18, there are a v-shaped upper concave base 181, an above-prism shading piece 182 and an upper groove (not shown in the figures) whose locations correspond to v-shaped lower concave base 174, below-prism shading piece 175 and a lower concave groove 176 respectively. As upper lid 18 covers up with lower lid 172, a space is formed between them. The optical engine 10 of the present invention is assembled as follows: prism module 14 is located in between above-prism shading piece 182 and below-prism shading piece 175. Converging lens 13 is located in between upper concave groove and lower concave groove 176. Concave mirror 12 is located in the corner formed by v-shaped upper concave base 181 and v-shaped lower concave base 174. At the end of v-shaped upper concave base 181 and v-shaped lower concave base 174, a taper rod 112, a fixing stand 115 and a spring clip 116 are furnished. In addition, below the prism module 14, there are a prism supporting piece 143 and a spring 144 to orientate and fine-tune the location of prism module 14. So, by means of the special invention of base 17 and upper lid 18, the other elements mentioned can be oriented in combination toward an expected angle, relative position and distance in a faster, easier and precise way.

As shown in FIG. 3, Digital Micromirror Device DMD 15 includes a DMD chip 151, a DMD outlet socket 152 to plug in DMD chip 151, a DMD PCB 153 to connect to DMD outlet socket 152, and a DMD electric connecting-socket 154 to connect to DMD PCB 153. As Digital Micromirror Device DMD 15 is installed in the space formed by base 17 and right cover 171, DMD chip 151 is exposed exactly on the central window of the first space 173 to accept light that comes from prism module 14. The projector lens set 16 is located in one side of the space formed in between above-prism shading piece 182 and below-prism shading piece 175. In addition to that, the projector lens set 16 includes a rubber case 163 and a fastening ring 164. The rubber case 163 is connected to projector lens set 16 externally and its edges fit exactly into the space formed by above-prism shading piece 182 and below-prism shading piece 175 to prevent light interference. The fastening ring 164 locks projector lens set 16 into an extension frame 177 of right cover 171.

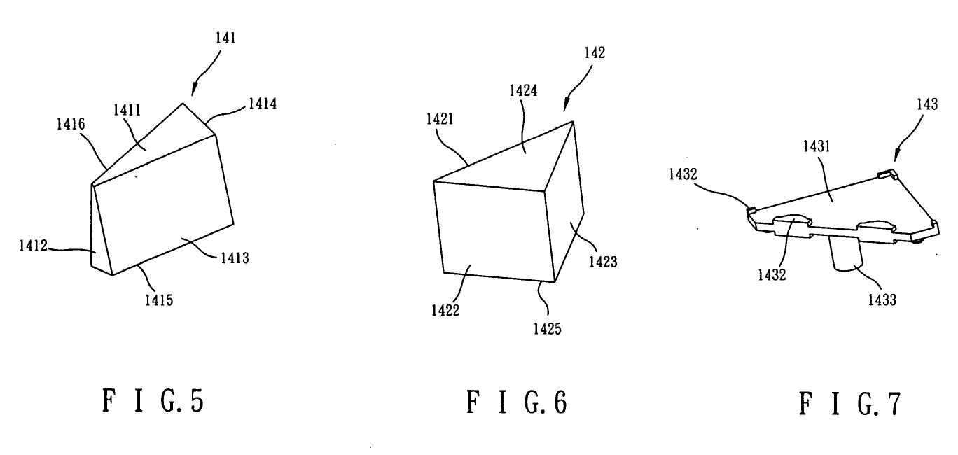

Please refer to FIG. 5, 6, and 7 as well as FIG. 2 and 4. FIG. 5 illustrates a 3-D diagram of the preferred embodiment of the first prism 141 of prism module 14 according to the invention. FIG. 6 illustrates a 3-D diagram of the preferred embodiment of the second prism 142 of prism module 14 according to the invention. FIG. 7 illustrates a 3-D diagram of the preferred embodiment of the prism supporting piece 143 of prism module 14 according to the invention. In this embodiment, the prism module 14 acts as a reversed total internal reflection (RTIR). The prism module 14 includes a first prism 141 and a second prism 142. The first prism 141 is located near the converging lens 13 and the second prism 142 is located near Digital Micromirror Device (DMD) 15. Both of these prisms are made of a transparent material with a predetermined refraction coefficient.

As shown in FIG. 5, the first prism 141 is a wedge prism which presents itself in pyramidal shape (FIG. 4) on the cross-sectional surface of the light ray as it travels along the track. The six surfaces 1411˜1416 of the wedge prism are flat surfaces which are not parallel to any other among themselves and each surface is connected to the other in a tilted way. Surface 1413 is the incident surface of light and surface 1416 is the light exit surface. The joining lines of the four surfaces 1411, 1412, 1413 and 1416 of the first prism 141 are very thin in thickness (i.e. surfaces 1413 and 1416 have the shortest distance in this location), but for surfaces 1413, 1414, 1415 and 1416, their joining lines are comparatively thick (i.e. surfaces 1413 and 1416 have the longest distance in this location).

Please refer to FIG. 6, in the embodiment, the second prism 142 presents itself on the cross-sectional surface of the traveling light ray as a right triangle which comprises five surfaces 1421˜1425. Surfaces 1424 and 1425 are right triangular surfaces which are parallel to each other. Surface 1421 is located in between these two surfaces and perpendicular to their longest sides. This surface serves as the incidence surface for light. Surfaces 1422 and 1423 are located perpendicularly to the other two sides of surfaces 1424 and 1425, respectively. These two surfaces are perpendicular to each other as well. The surface 1416 of the first prism 141 is equipped against surface 1421 (the surface extended from the longest edge of the right triangle) of the second prism 142. Digital Micromirror Device (DMD) 15 and projection lens set 16 are adjacent to surfaces 1423 and 1422 (the two surfaces extended from the two perpendicular sides of the right triangle) of the second prism 142.

As shown in FIG. 7, the prism supporting piece 143 has a right triangular supporting surface 1431 for surface 1425 of the second prism 142 to sit on. The second prism 142 can be glued on the prism supporting piece 143. In the edges of supporting surface 1431 of the prism supporting piece 143, several resisting pieces 1432 can be used to prevent the second prism 142 from sliding. Underneath the prism supporting piece 143, there is a screwing column 1433 (not shown in the figures) for screwing base 17 to the below-prism shading piece 175. Through fine screwing movement of the screw, the relative position and angle of the first prism 141 and the second prism 142 can be adjusted, so as to fine-tune the direction and angle of the light ray.

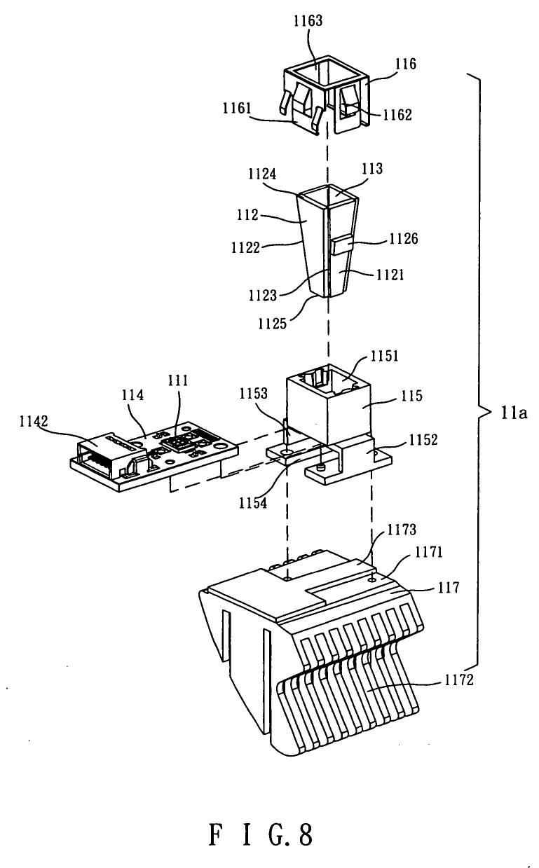

FIG. 8 is a similar exploding diagram to FIG. 2 which shows the first embodiment of an illuminator module 11 of the optical engine 10 according to the invention. This illuminator module 11 includes a light source 111, a taper rod 112, light reflection piece, a PCB 114, a fixing column 115 and a spring clip 116. This illuminator module 11 also combines a heat-dissipating component 117 to dissipate heat.

Light source 111 is set to emit light ray toward in the direction of a predetermined light axis. In an embodiment, light source 111 is a light emitting diode (LED). The taper rod 112 is adjacent to light source 111. The taper rod 112 includes a plurality of narrow and long surfaces 1121 along the extended direction of the light source. The perpendicular cross-sectional surface of the taper rod 112 and the light axis forms a polygon in this way. Each of narrow and long surfaces 1121 has two corresponding long edges 1122 and 1123 that generally extend along the direction of the light source and two corresponding short edges 1124 and 1125 that are generally perpendicular to the light axis. The length of the narrow and long surface 1121 nearer to the short edge 1125 of the light source is shorter compared with the short edge 1124 of the light source. So, the taper rod 112 becomes bigger gradually in the direction departing away from the light source 111. The concave mirror 12 is located at the end where the cross-sectional area of the taper rod 112 is the largest.

The reflecting means is implemented to the narrow and long surface 1121 to reflect light ray emitted from the light source and guides it toward the direction of the light axis. A preferred embodiment is shown in FIG. 8. The taper rod 112 is a hollow cone made of transparent material, for example, glass, plastics, crystal or quartz, but not limited to these. The interior surfaces of the narrow and long surface 1121 are formed with light reflective materials 113 (e.g. Silver, etc.) so that total reflection occurs as the light travels from the end with the smaller cross-sectional area to the end of the larger cross-sectional area of the taper rod 112. In this way, the taper rod 112 invented guides the traveling light toward the axis of the light.

PCB 114 is used for supporting the light source 111 (Light Emitting Diode, LED). There are several electrical elements (not numbered) of a light source drive 111 (Light Emitting Diode, LED) and a connector 1142. The fixing stand 115 is connected to PCB 114. On the fixing stand 115, a square-shaped hollow sink 1151 is used for installing the end with the smaller cross-sectional area of the taper rod 112 and the location of the light source 111 corresponds exactly to the end with the smaller cross-sectional area of the taper rod 112. The fixing stand 115 includes two stands 1152 and 1153 and a sliding route 1154 in between them. The size of the sliding route 1154 matches exactly with the size of PCB 114 so that PCB 114 can slide into the sliding route 1154 to attach with the fixing stand 115.

Spring clip 116 is used to clip the taper rod 112 to the fixing stand 115. In a preferred embodiment, the spring clip 116 includes a plurality of clips 1161, at least one buttoning clip 1162 on each Clip 1161 and a hole 1163 on each clip 1161. The size of the hole 1163 is greater than the larger cross-sectional area end of the taper rod 112. The taper rod 112 is fixed to the fixing stand 115 with the hole 1163 of the spring clip 116 encases upon the taper rod 112 and with the help of at least a clip 1161 to clip onto the edge of fixing stand 115. In a preferred embodiment, a convex piece 1126 is devised on at least on one of the narrow and long surface 1121 of the taper rod 112 so when the hole 1163 of the spring clip 116 encases upon the taper rod 112, the convex piece 126 serves to go against the spring clip 116 and the fixing stand 115 to prevent occurrence of displacement.

The heat sink module 117 includes a heat dissipating surface 1171 and a plurality of heat dissipating fins 1172 extended from the heat dissipating surface 1171. On the heat dissipating surface 1171, there is a convex surface 1173 with predetermined shape. The fixing stand 115 and the PCB 114 are connected to the heat dissipating surface 1171. The location of the convex surface 1173 forms exactly a space with the two stands 1152 and 1153 so that the light source 111 on PCB 114 may be contacted to the convex surface 1173 on the heat dissipating surface 1171.

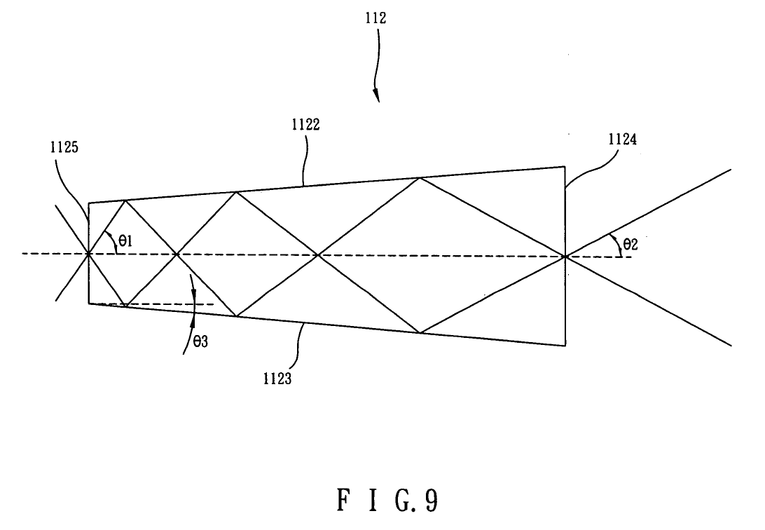

FIG. 9 shows a diagram of an embodiment of the light is reflected along the way through the taper rod 112 according to the invention. The special structure of the taper rod 112 is designed in the purpose of minimizing light scattering angle. As shown in FIG. 9, light travels into the end with the smaller cross-sectional surface of the taper rod 112 in θ₁ angle and the taper rod 112 itself gets larger gradually (i.e. the cross-sectional area gets larger) in θ₃ angle with the traveling light source, so when the light gets out of the end with the larger cross-sectional surface in the angle of θ₂, where θ₂<θ₁. In this way, the scattering angle of the light is minimized and the light ray is gathered, distribution of the light is more even and the utilizing effectiveness is maximized.

Most of the elements that come in the following introduction, other preferred embodiment of the present invention are similar or the same to the above introduced examples. So, we only add an alphabet to the listed number to differentiate.

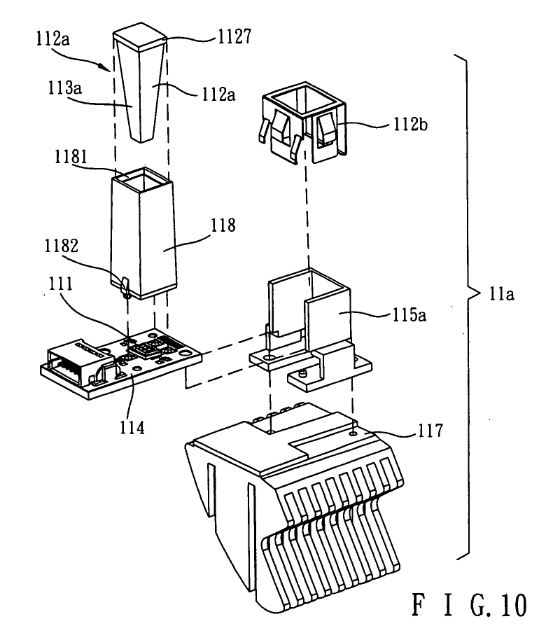

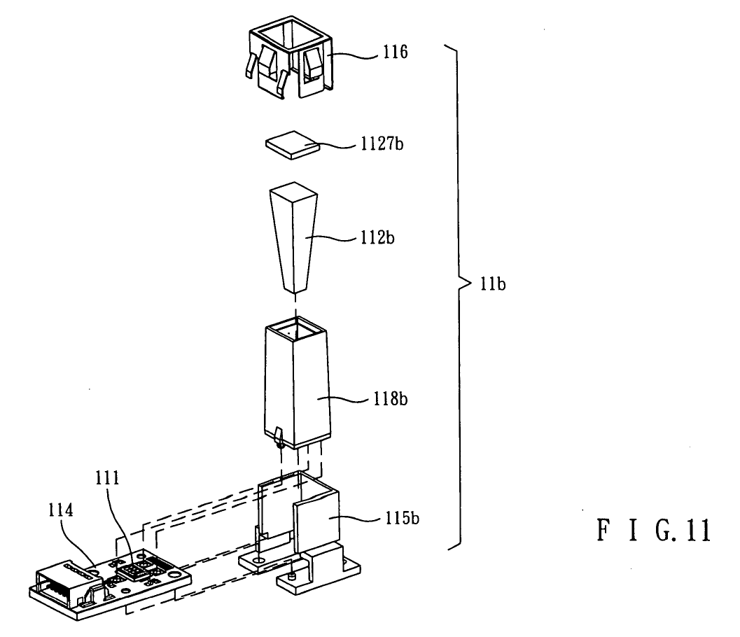

FIG. 10 illustrates a block diagram of a second embodiment of the illuminator module 11a of the optical engine according to the invention. The illuminator module 11a shown here in FIG. 10 is similar to the illuminator module 11 shown in FIG. 8 in that, it also includes: light source 111 (light emitting diode, LED), taper rod 112a, light reflection piece, PCB module 114, a fixing stand 115a and a spring clip 116. It also has a heat dissipating element 117 to dissipate heat. The difference in illuminator module 11a is that it has a hollow oriented casing 118 and at the end of the larger cross-sectional area of the taper rod 112a, there is a bulging edge 1127. The taper rod 112a is transfixed into the hollow oriented casing 118 so that the bulging edge 1127 is fixed on the upper and inner fold 1181 of the hollow oriented casing 118. The other end of the casing 118 is fixed to the PCB module 114 and the fixing stand 115a through connecting element 1182. The taper rod 112a is a solid pyramid. There are light reflecting means on the outer narrow and long surfaces 1121a made of light reflecting material 113a. Besides, the bulging edge 1127 of the taper rod 112a and the taper rod 112a are made of one piece.

FIG. 11 illustrates a block diagram of a third embodiment of the illuminator module 11b. According to FIG. 11, illuminator module 11b is similar to illuminator module 11a in general. It also includes: a light source 111 (light emitting diode), taper rod 112b, a light reflection piece, PCB 114, a fixing stand 115b, a spring clip 116 and an oriented casing 118b. The difference between the two illuminator modules is that the bulging edge 1127b of the taper rod 112b is an independent part from the taper rod and it is made of a transparent piece-like material (e.g. Glass or acrylic resin) whose size is a bit larger than the larger cross-sectional surface of the taper rod 112b. Besides, the bulging edge is glued to the pole 112b.

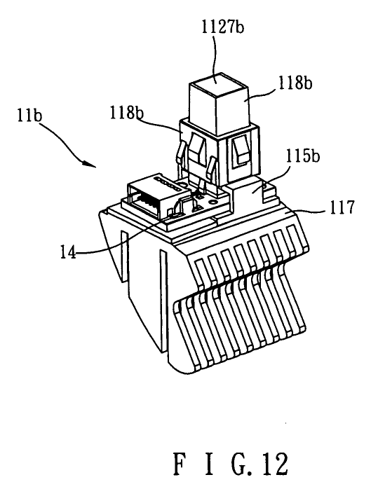

FIG. 12 shows the combination diagram of the heat dissipating element 117 to the illuminator module 11b shown in FIG. 11.

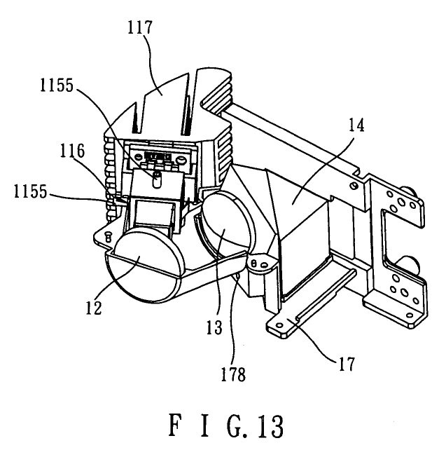

FIG. 13 shows the combination diagram of the base 17, the concave mirror 12, the converging lens 13 and the prism set 14 to the illuminator module 11b shown in FIG. 12.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. An optical engine comprising:
an illuminator module, said illuminator module further comprising:
a light source for generating a light toward a direction of a predetermined light axis;
a taper rod having a first end being adjacent to the light source, the taper rod comprising a plurality of narrow and long surfaces along the extended direction of the light axis, wherein a perpendicular cross-sectional surface of the taper rod and the light axis forms a polygon, each narrow and long surface has two corresponding long edges that generally extend along the direction of the light axis, and two corresponding short edges that are generally perpendicular to the light axis, and the length of the narrow and long surfaces nearer to a short edge of the light source is shorter compared with the short edge of the light source such that the cross-sectional surface of the taper rod becomes bigger gradually in the direction departing away from the light source; and
a reflecting means which is implemented to the narrow and long surfaces to reflect the light from the light source and guides it toward the direction of the light axis.

2. The optical engine according to claim 1, wherein the taper rod is a hollow cone made of transparent material, and the light reflecting means is a light reflective material formed on the interior surfaces of the narrow and long surfaces.

3. The optical engine according to claim 1, wherein the taper rod is a solid pyramid, and the light reflecting means is a light reflective material formed on the outer surfaces of the narrow and long surfaces.

4. The optical engine according to claim 1, wherein the taper rod is made of a transparent material.

5. The optical engine according to claim 1, wherein the illuminator module further comprises:
a light emitting diode (LED), for generating the light;
a printed circuit board (PCB), for supporting the LED;
a fixing stand, connected to the PCB and having a hollow sink, wherein the hollow sink is used for installing the end with the smaller cross-sectional area of the taper rod and the location of the LED corresponds exactly to the end with the smaller cross-sectional area of the taper rod; and
a spring clip for clipping the taper rod to the fixing stand.

6. The optical engine according to claim 1, wherein the fixing stand comprises a first stand, a second stand and a sliding route which is between the first stand and the second stand, wherein the size of the sliding route matches exactly with the size of PCB so that PCB slides into the sliding route to attach with the fixing stand.

7. The optical engine according to claim 6, further comprising:
a heat sink module comprising a heat dissipating surface and a plurality of heat dissipating fins extended from the heat dissipating surface, the heat dissipating surface comprising a convex surface with predetermined shape;
wherein the fixing stand and the PCB are connected to the heat dissipating surface, and the location of the convex surface forms exactly a space with the first and the second stands so that the light source on the PCB is contacted to the convex surface of the heat dissipating surface.

8. The optical engine according to claim 5, wherein the spring clip comprises a plurality of clips, at least one buttoning clip on one of the clips and a plurality of holes corresponding to the clips, the size of the hole is greater than the larger cross-sectional area end of the taper rod, the taper rod is fixed to the fixing stand with the hole of the spring clip encases upon the taper rod and with the help of at least a clip to clip onto the edge of fixing stand.

9. The optical engine according to claim 5, wherein the illuminator module comprises a hollow oriented casing, the end of the larger cross-sectional area of the taper rod has a bulging edge, the taper rod is transfixed into the hollow oriented casing so that the bulging edge is fixed on the upper and inner fold of the hollow oriented casing, and the other end of the hollow oriented casing is fixed to the PCB and fixing stand.

10. The optical engine according to claim 9, wherein the bulging edge of the taper rod is an independent component, the bulging edge of the taper rod is made of a transparent piece-like material whose size is a bit larger than the larger cross-sectional surface of the taper rod.

11. The optical engine according to claim 5, further comprising:
a concave mirror, which is located at the end of the cross-sectional area of the taper rod, for refracting and converging the light which is guided toward the direction of a light axis;
a light condenser for receiving and converging the light from the concave mirror;
a prism module for receiving and refracting the light from the light condenser;
a Digital Micromirror Device (DMD) for receiving the light from the prism module to form an image, and refracting the image to the prism module; and
a projection lens set, for focusing the image and forming on an external projection surface.

12. The optical engine according to claim 11, wherein the prism module is a reversed total internal reflection (RTIR), the RTIR comprises:
a first prism which is located near the light condenser; and
a second prism, which is located near the Digital Micromirror Device (DMD) and the projection lens set;
wherein the first prism is a wedge prism which presents itself in on the cross-sectional surface of the light as a pyramidal shape, the second prism presents itself on the cross-sectional surface of the traveling light as a right triangle, the first prism leans against the surface drawn from an edge of the right triangle along the cross-sectional surface formed by the second prism.

13. The optical engine according to claim 11, further comprising:
a base comprising:
a right cover for forming a first space to contain the Digital Micromirror Device (DMD); and
a lower lid for forming a v-shaped lower concave base and a below-prism shading piece connected in adjacent to the right cover, wherein a lower concave groove is located between the v-shaped lower concave base and the below-prism shading piece;
and
a upper lid for connecting the lower lid of base, the upper lid comprising a v-shaped upper concave base, an above-prism shading piece and an upper groove whose locations correspond to the v-shaped lower concave base, the below-prism shading piece and a lower concave groove, respectively, wherein a space is formed when the upper lid covers up with lower lid;
wherein the prism module is located in between the above-prism shading piece and the below-prism shading piece, the light condenser is located in between the upper concave groove and the lower concave groove, the concave mirror is located in the corner formed by the v-shaped upper concave base and the v-shaped lower concave base;
wherein the end of the v-shaped upper concave base and the v-shaped lower concave base contain the taper rod and the fixing stand.

14. The optical engine according to claim 13, wherein the Digital Micromirror Device (DMD) comprises a DMD chip, a DMD outlet socket for connecting to the DMD chip, a DMD printed circuit board (PCB) for connecting to the DMD outlet socket; and a DMD power socket for connecting to the DMD PCB.

15. The optical engine according to claim 13,
wherein the projector lens set is located in one side of the space formed in between the above-prism shading piece and the below-prism shading piece, the projector lens set comprises a rubber case and a fastening ring;
wherein the rubber case is connected to projector lens set externally and its edges fits exactly into the space formed by the above-prism shading piece and the below-prism shading piece to prevent light interference; and
wherein the fastening ring locks projector lens set into an extension frame of the right cover.

16. An optical engine comprising:
an illuminator module for generating a light which is guided toward a direction of a light axis;
a light condenser for receiving and converging the light from the illuminator module; and
a reversed total internal reflection (RTIR) for receiving and refracting the light from the light condenser;
wherein the reversed total internal reflection (RTIR) comprises:
a first prism which is located near the light condenser; and
a second prism, which is located far the light condenser;
wherein the first prism is a wedge prism which presents itself in on the cross-sectional surface of the light as a pyramidal shape, the second prism presents itself on the cross-sectional surface of the traveling light as a right triangle, the first prism leans against the surface drawn from an edge of the right triangle along the cross-sectional surface formed by the second prism;
wherein the refraction angle and direction of the light are controlled through turning the relative position of the first prism and the second prism.

17. The optical engine according to claim 16, wherein the illuminator module comprises:
a light source for generating a light;
a taper rod having a first end being adjacent to the light source, the taper rod comprising a plurality of narrow and long surfaces along the extended direction of the light axis, wherein a perpendicular cross-sectional surface of the taper rod and the light axis forms a polygon, each narrow and long surface has two corresponding long edges that generally extend along the direction of the light axis, and two corresponding short edges that are generally perpendicular to the light axis, and the length of the narrow and long surfaces nearer to a short edge of the light source is shorter compared with the short edge of the light source such that the cross-sectional surface of the taper rod becomes bigger gradually in the direction departing away from the light source; and
a reflecting means which is implemented to the narrow and long surfaces to reflect the light from the light source and guides it toward the direction of the light axis.

18. The optical engine according to claim 17, wherein the illuminator module further comprises:
a light emitting diode (LED), for generating the light;
a printed circuit board (PCB), for supporting the LED;
a fixing stand, connected to the PCB, having a hollow sink, wherein the hollow sink is used for installing the end with the smaller cross-sectional area of the taper rod and the location of the LED corresponds exactly to the end with the smaller cross-sectional area of the taper rod; and
a spring clip for clipping the taper rod to the fixing stand;
wherein the fixing stand comprises a first stand, a second stand and a sliding route which is between the first stand and the second stand, wherein the size of the sliding route matches exactly with the size of PCB so that PCB slides into the sliding route to attach with the fixing stand;
wherein the optical engine further comprising a heat dissipating element comprising a heat dissipating surface and a plurality of heat dissipating fins extended from the heat dissipating surface, the heat dissipating surface comprising a convex surface with predetermined shape, wherein the fixing stand and the PCB are connected to the heat dissipating surface, and the location of the convex surface forms exactly a space with the first and the second stands so that the light source on the PCB is contacted to the convex surface of the heat dissipating surface; and
wherein the spring clip comprises a plurality of clips, at least one buttoning clip on one of the clips and a plurality of holes corresponding to the clips, the size of the hole is greater than the larger cross-sectional area end of the taper rod, the taper rod is fixed to the fixing stand with the hole of the spring clip encases upon the taper rod and with the help of at least a clip to clip onto the edge of fixing stand.

19. The optical engine according to claim 17, further comprising:
a concave mirror, which is located at the end of the cross-sectional area of the taper rod, for refracting and converging the light which is guided toward the direction of a light axis, the reversed total internal reflection (RTIR) being for receiving and refracting the light from the concave mirror;
a Digital Micromirror Device (DMD) for receiving the light from the reversed total internal reflection (RTIR) to form an image, and refracting the image to the prism module; and
a projection lens set, for focusing the image and forming on an external projection surface.

20. The optical engine according to claim 19, further comprising:
a base comprising:
a right cover for forming a first space to contain the Digital Micromirror Device (DMD); and
a lower lid for forming a v-shaped lower concave base and a below-prism shading piece connected in adjacent to the right cover, wherein a lower concave groove is located between the v-shaped lower concave base and the below-prism shading piece;
and
a upper lid for connecting the lower lid of base, the upper lid comprising a v-shaped upper concave base, an above-prism shading piece and an upper groove whose locations correspond to the v-shaped lower concave base, the below-prism shading piece and a lower concave groove, respectively, wherein a space is formed when the upper lid covers up with lower lid;
wherein the reversed total internal reflection (RTIR) is located in between the above-prism shading piece and the below-prism shading piece, the light condenser is located in between the upper concave groove and the lower concave groove, the concave mirror is located in the corner formed by the v-shaped upper concave base and the v-shaped lower concave base;
wherein the end of the v-shaped upper concave base and the v-shaped lower concave base contain the taper rod and the fixing stand; and
wherein the Digital Micromirror Device (DMD) comprises a DMD chip, a DMD outlet socket for connecting to the DMD chip, a DMD PCB for connecting to the DMD outlet socket; and a DMD power socket for connecting to the DMD PCB.

21. An optical engine comprising:
a light source for generating a light which is guided toward a direction of a light axis;
a taper rod having a first end being adjacent to the light source, wherein the cross-sectional surface of the taper rod becomes bigger gradually in the direction departing away from the light source, the light from the light source is guided toward the direction of the light axis by the taper rod;
at least one light condenser for receiving and converging the light from the light source;
a prism module for receiving and refracting the light from the light condenser;
a Digital Micromirror Device (DMD) for receiving the light from the prism module to form an image, and refracting the image to the prism module; and
a projection lens set, for focusing the image and forming on an external projection surface.

22. The optical engine according to claim 21, wherein the at least one light condenser comprises:
a concave mirror, which is located at the end of the cross-sectional area of the taper rod, for refracting and converging the light which is guided toward the direction of a light axis; and
a converging lens for receiving and converging the light from the concave mirror;
wherein the prism module is a reversed total internal reflection (RTIR), the RTIR comprises:
a first prism which is located near the converging lens; and
a second prism, which is located near the Digital Micromirror Device (DMD) and the projection lens set;
wherein the first prism is a wedge prism which presents itself in on the cross-sectional surface of the light as a pyramidal shape, the second prism presents itself on the cross-sectional surface of the traveling light as a right triangle, the first prism leans against the surface drawn from an edge of the right triangle along the cross-sectional surface formed by the second prism.

23. An image projector comprising:
an optical engine for generating an image;
a printed circuit board (PCB) module, connected to the optical engine, for controlling the operation of the optical engine;
a heat sink module for dissipating the heat of the optical engine and the PCB module;
a operation interface module, connected to the PCB module, for controlling the operation of the image projector; and
a casing for assembling the optical engine, the PCB module, the heat sink module, and the operation interface module;
wherein the optical engine comprises:
a light source for generating a light which is guided toward a direction of a light axis;
a taper rod having a first end being adjacent to the light source, the taper rod comprising a plurality of narrow and long surfaces along the extended direction of the light axis, wherein a perpendicular cross-sectional surface of the taper rod and the light axis forms a polygon, each narrow and long surface has two corresponding long edges that generally extend along the direction of the light axis, and two corresponding short edges that are generally perpendicular to the light axis, and the length of the narrow and long surfaces nearer to a short edge of the light source is shorter compared with the short edge of the light source such that the cross-sectional surface of the taper rod becomes bigger gradually in the direction departing away from the light source; and
a reflecting means which is implemented to the narrow and long surfaces to reflect the light from the light source and guides it toward the direction of the light axis.

24. An image projector comprising:
an optical engine for generating an image;
a printed circuit board (PCB) module, connected to the optical engine, for controlling the operation of the optical engine;
a heat sink module for dissipating the heat of the optical engine and the PCB module;
a operation interface module, connected to the PCB module, for controlling the operation of the image projector; and
a casing for assembling the optical engine, the PCB module, the heat sink module, and the operation interface module;
wherein the optical engine comprises:
an illuminator module for generating a light which is guided toward a direction of a light axis;
a light condenser for receiving and converging the light from the light source; and
a reversed total internal reflection (RTIR) for receiving and refracting the light from the light condenser, the RTIR comprising:
a first prism which is located near the light condenser; and
a second prism, which is located near the Digital Micromirror Device (DMD) and the projection lens set;
wherein the first prism is a wedge prism which presents itself in on the cross-sectional surface of the light as a pyramidal shape, the second prism presents itself on the cross-sectional surface of the traveling light as a right triangle, the first prism leans against the surface drawn from an edge of the right triangle along the cross-sectional surface formed by the second prism.
wherein the refraction angle and direction of the light are controlled through turning the relative position of the first prism and the second prism.

25. An image projector comprising:
an optical engine for generating an image;
a printed circuit board (PCB) module, connected to the optical engine, for controlling the operation of the optical engine;
a heat sink module for dissipating the heat of the optical engine and the PCB module;
a operation interface module, connected to the PCB module, for controlling the operation of the image projector; and
a casing for assembling the optical engine, the PCB module, the heat sink module, and the operation interface module;
wherein the optical engine comprises:
a light source for generating a light which is guided toward a direction of a light axis;
a taper rod having a first end being adjacent to the light source, wherein the cross-sectional surface of the taper rod becomes bigger gradually in the direction departing away from the light source, the light from the light source is guided toward the direction of the light axis by the taper rod;
at least one light condenser for receiving and converging the light from the light source;
a prism module for receiving and refracting the light from the light condenser;
a Digital Micromirror Device (DMD) for receiving the light from the prism module to form an image, and refracting the image to the prism module; and
a projection lens set, for focusing the image and forming on an external projection surface.
